(19) United States
(12) Patent Application Publication
(10) Pub. No.: US 2018/0037484 A1
(43) Pub. Date: Feb. 8, 2018

(54) System and Method for Purifying Water

(71) Applicant: Patrick Michael Poulson, Blackwell, OK (US)

(72) Inventor: Patrick Michael Poulson, Blackwell, OK (US)

(21) Appl. No.: 15/783,557

(22) Filed: Oct. 13, 2017

Related U.S. Application Data
(63) Continuation of application No. 14/637,022, filed on Mar. 3, 2015.

(51) Int. Cl. C02F 9/00; C02F 1/38; C02F 1/46

(52) U.S. Cl. CPC C02F 9/00; C02F 2201/46; C02F 1/4608; C02F 1/385

(57) ABSTRACT

A water purifying and recovery system includes a first vessel defining an interior area and having an inlet for receiving water into the interior area to be purified and an outlet for draining the water from the interior area, the first vessel defining an open top in communication with the interior area. A first electrode assembly includes a first cap selectively situated in the open top of the first vessel, the first electrode assembly having a first electrode body operatively depending from the first cap and positioned in the interior area of the first vessel, the first electrode assembly being electrically connected to an electricity source and configured to energize the first electrode body. The first electrode assembly is configured to separate a predetermined first impurity from the water that is in the interior area of the first vessel when energized.

### REFERENCE TO RELATED APPLICATIONS

This application is related to U.S. patent application Ser. No. 14/637,022, filed Mar. 3, 2015 by the present applicant entitled System and Method for Purifying Water which is incorporated herein by reference in its entirety.

### BACKGROUND OF THE INVENTION

This invention relates generally to water purification systems and, more particularly to an electrode water purification system that separates predetermined impurities from water using an electrode associated with the predetermined impurity of diversified size and molecular structure and a centrifuge. The system purifies water without chemicals or filters.

Impurities in water can range from just causing cloudiness or discoloration to being harmful when ingested. Solid impurities that are found in water may come naturally from minerals (as in the case of magnesium and copper), may be naturally abundant in natural ground water supplies (as in the case of iron), or be left over from industrial waste products (as in the case of lead and chromium). In these examples, it is desirable to remove the impurity in a manner that results in purified water that is both clear and safe.

Various devices and methods have been proposed in the art to reduce or eliminate impurities in water. Although presumably effective for their intended purposes, many of the purification processes require large amounts of chemical additives which can themselves have negative effects on the water or those consuming it later. In addition, some of the known processes may require the use of filters that can become clogged with solid impurities that are blocked from passage through the filter medium or centrifuges being oversaturated with sludge from polymers used that gum up the system.

Therefore, it would be desirable to have a water purification and recovery system that utilizes an electrode assembly specifically configured to separate the molecular bonds between a predetermined impurity of diversified size and molecular structure and water. Further, it would be desirable to have a water purification and recovery system that collects and recovers solid particulate impurities after being separated from a water stream. In addition, it would be desirable to have a water purification and recovery system that includes more than one water vessel and electrode assembly so that different impurities can be separated from a single water stream.

### SUMMARY OF THE INVENTION

A water purifying and recovery system according to the present invention includes a first vessel defining an interior area and having an inlet for receiving water into the interior area to be purified and an outlet for draining the water from the interior area, the first vessel defining an open top in communication with the interior area. A first electrode assembly includes a first cap selectively situated in the open top of the first vessel, the first electrode assembly having a first electrode body operatively depending from the first cap and positioned in the interior area of the first vessel, the first electrode assembly being electrically connected to an electricity source and configured to energize the first electrode body. The first electrode assembly is configured to separate a predetermined first impurity from the water that is in the interior area of the first vessel when energized.

Therefore, a general object of this invention is to provide a water purifying and recovery system that separates a predetermined impurity from water.

Another object of this invention is to provide a water purifying and recovery system, as aforesaid, that energizes an electrode with sufficient amperage to break the molecular bond between the predetermined impurity and water.

Still another object of this invention is to provide a water purifying and recovery system, as aforesaid, that utilizes an electrode constructed of a particular metal associated with the predetermined impurity to be separated.

Yet another object of this invention is to provide a water purifying and recovery system, as aforesaid, in which the principle of sedimentation using centripetal acceleration displaces the separated impurity from a water stream and allows it to be collected for alternative uses.

A further object of this invention is to provide a water purifying system, as aforesaid, that is configured to remove one or more than one type of impurity from a single water stream.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a water purifying and recovery system according to a preferred embodiment of the present invention;

FIG. 2 is an exploded view of a portion of the system as in FIG. 1;

FIG. 3 is a perspective view of an electrode assembly;

FIG. 4 is a perspective view of a water treatment vessel according to the present invention;

FIG. 5a is a top view of a portion of the system as in FIG. 1;

FIG. 5b is a section view taken along line 5b-5b of FIG. 5a;

FIG. 6a is a perspective view of a centrifuge taken from FIG. 1;

FIG. 6b is a perspective view from another angle of the centrifuge as in FIG. 6a;

FIG. 7 is a perspective view of a water purifying and recovery system according to a another embodiment of the present invention;

FIG. 8 is a top view of a water treatment vessel illustrated with enhanced reaction members; and

FIGS. 9 to 11 are flowcharts illustrating exemplary processes according to the method of water purification according to the present invention.

### DESCRIPTION OF THE PREFERRED EMBODIMENT

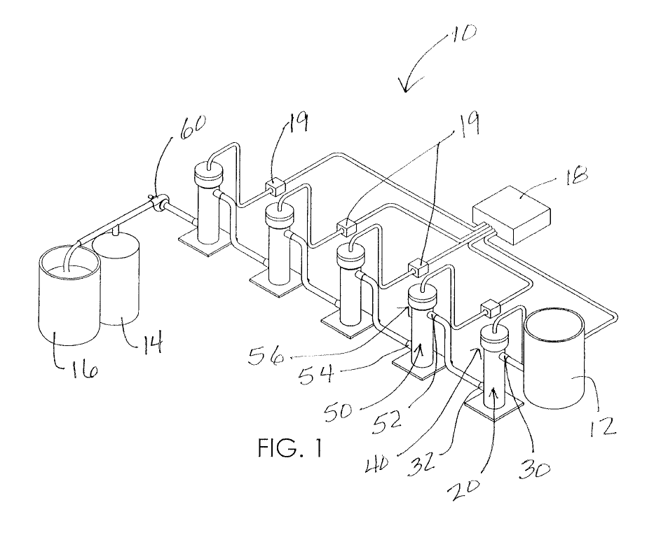

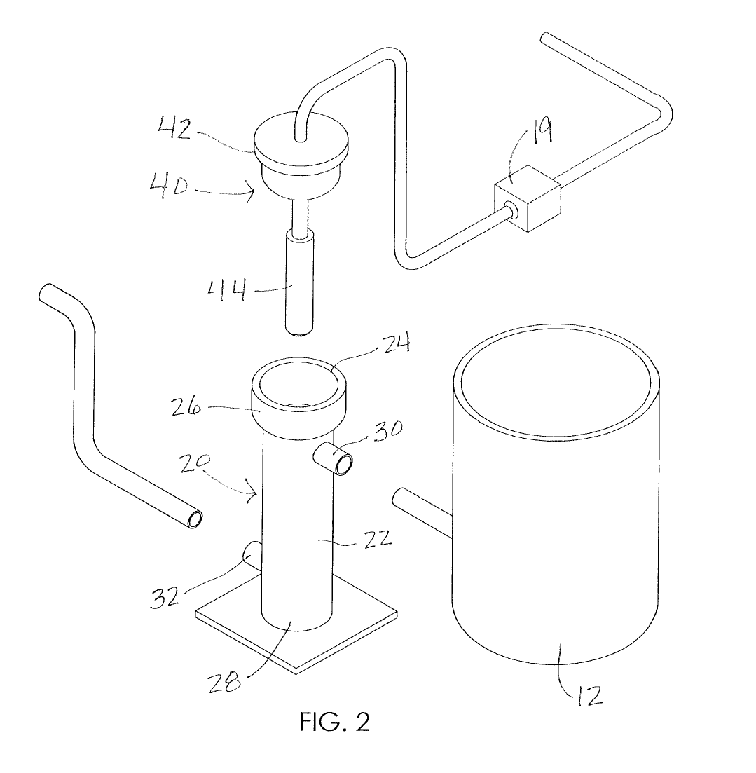

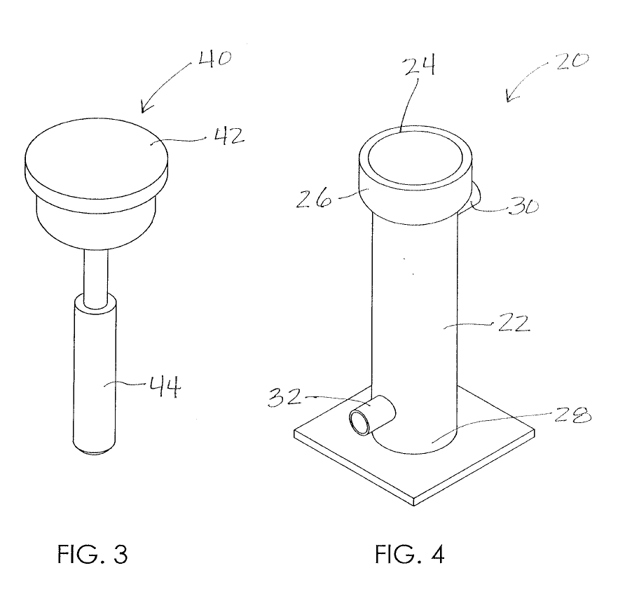

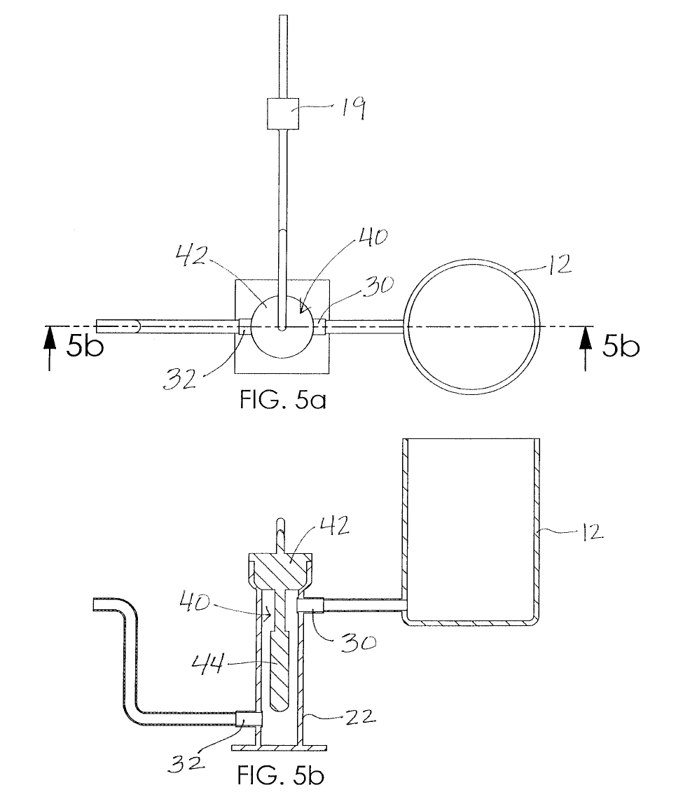

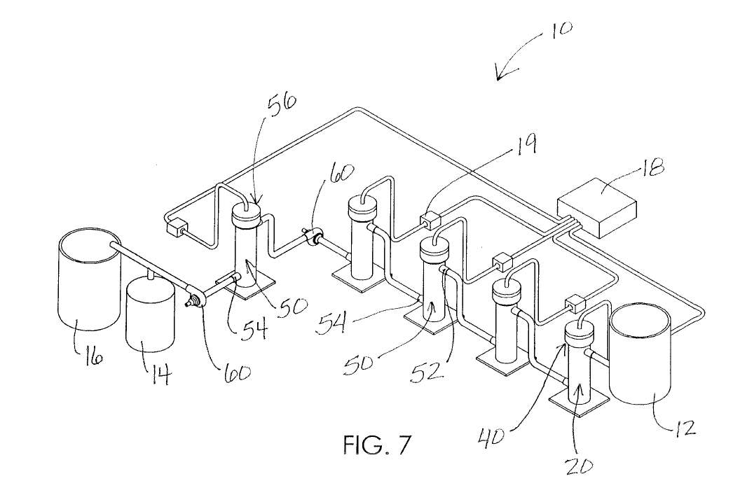

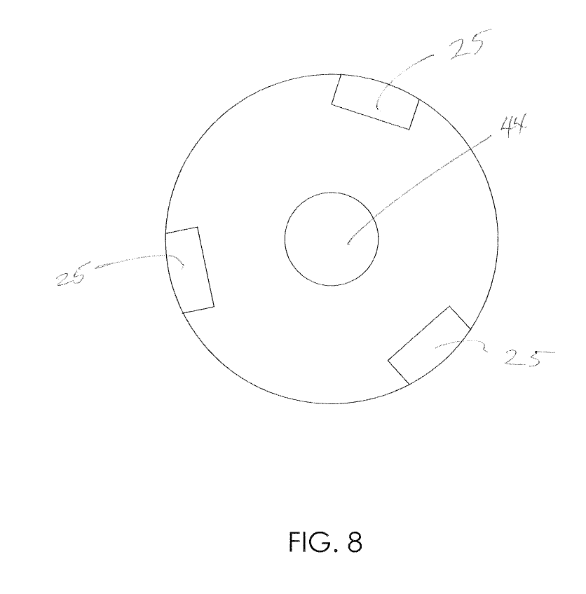

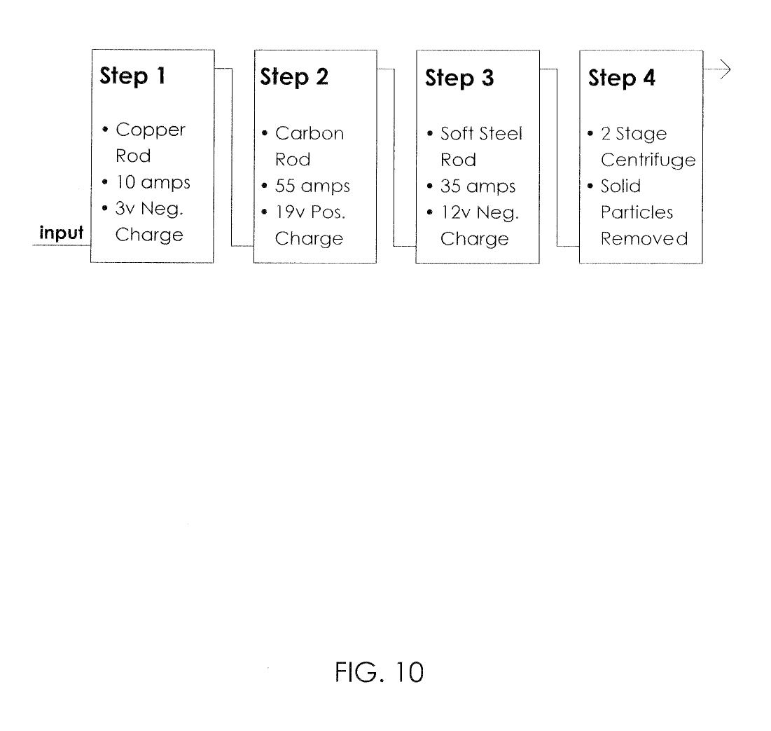

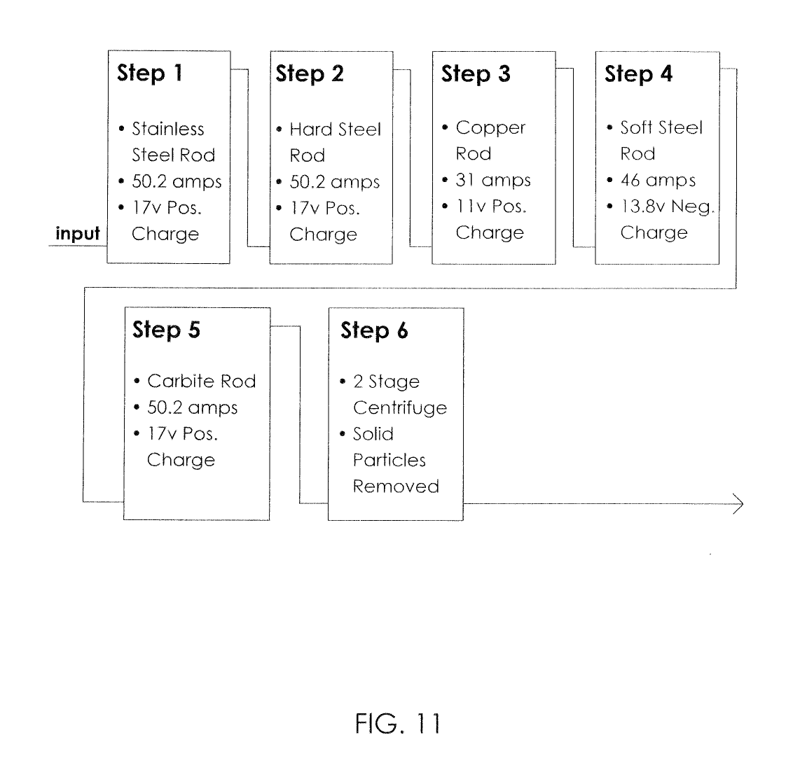

A water purifying and recovery system according to embodiments of the present invention will now be described in detail with reference to FIGS. 1 to 11 of the accompanying drawings. The water purifying and recovery system 10 includes at least a first vessel 20 configured to contain a first electrode assembly 40 that is configured to separate a predetermined impurity from a water stream.

The water purifying and recovery system 10 includes a first vessel 20 that defines an interior area configured to contain a fluid such as raw water. The first vessel 20 may have a generally cylindrical configuration that defines an inlet 30 at an upper end 26 thereof and an outlet 32 at a lower end 28 thereof. The inlet 30 may be in fluid communication, such as with a pipe or conduit, with a water tank 12 that contains a quantity of raw water intended to be purified by the present system 10. Water is allowed to flow into the interior area through the inlet 30 so that it may be treated or processed. In addition, the first vessel 20 includes an outer wall 22 defining an open top 24 adjacent the upper end 26. In an embodiment having more than one vessel, the inlet of a downstream vessel may be in fluid communication with a respective outlet 32 of an upstream vessel, as will be described later.

The open top 24 is selectively positioned in the interior area of the first vessel 20 adjacent the open top. The first electrode assembly 40 closes the open top 24 when inserted into the interior area and, therefore, prevents access to the interior area other than water flowing in through the inlet 30. The first vessel 20 includes an inner surface adjacent the open top 24 that defines a plurality of threads. In a complementary manner, the first electrode assembly 40 includes a first cap 42 having an outer surface defining a plurality of threads such that the first cap 42 may be threadably coupled to the first vessel 20.

The first electrode assembly 40 includes a first electrode body 44 coupled to and extending downwardly from the first cap 42 so as to be situated in the interior area when the first electrode assembly 40 is coupled to the first vessel 20. The first electrode body 44 is sometimes referred to as a rod. The first electrode assembly 40 and, as a result, the first electrode body 44 is electrically connected to an electrical power source 18, such as a traditional AC source of electrical current. In an embodiment, AC power may be converted to DC current with one or more first electrode body 44 situated between the AC current source and a respective vessel (FIG. 1).

When energized, the first electrode body 44 is configured to cause a first predetermined impurity, such as a predetermined metal, to separate from respective water molecules such that the impurity may be separated from the water stream and collected. It is understood that the polarity of current may also be set to either positive or negative polarity. More particularly, the first electrode body 44 is constructed of a predetermined metal specifically configured to separate respective molecules of water (H₂O) from molecules of the predetermined associated impurity. In an embodiment, the metal from which the first electrode body 44 is constructed is taken from a group that includes copper, lead, nickel, aluminum, steel, cast iron, and carbide. It is understood that the electrode body may be selected and configured depending on the particular impurity to be separated out of the water. Stated even more directly, the metal from which the first electrode body is constructed and the particular amperage and polarity of the electrical current supplied to energize the first electrode body is associated with the first impurity to be filtered out of the water.

In addition, the first electrode body 44 may include an amperage requirement that is sufficient to separate a selected impurity from the water within or flowing through the first vessel 20. In combination, the metal construction and amperage requirement of the first electrode body 44 is configured to break the molecular bonds of an impurity from the water molecules.

The first electrode assembly 40 is removable from the first vessel 20 and interchangeable with a second electrode assembly 56 that is configured to separate a second predetermined impurity from a water stream that is in or flowing through the first vessel 20. In other words, the configuration of the second electrode assembly 56 may be different than a configuration of the first electrode assembly 40. This difference may include differences in metallic construction, amperage requirements of respective electrode bodies, or the like that are associated with a respective impurity to be removed or filtered from the water stream.

Similarly, the water purifying and recovery system 10 may include a plurality of additional vessels each having a construction substantially as the first vessel 20 described above unless described differently below. The one or more additional vessels will be described herein as a second vessel 50. The second vessel 50 includes a second vessel inlet 52 in fluid communication with a respective outlet 32 of a previous or upstream vessel, such as the first vessel 20 described above. The second vessel 50 also defines a second vessel outlet 54 in fluid communication with a downstream vessel or a centrifuge. The second electrode assembly 56 is configured for attachment to the second vessel 50 in substantially the same manner as described above with respect to first vessel 20. Similarly, the second electrode assembly 56 includes a second electrode body having a construction substantially similar to that of the first electrode body 44 although it is anticipated the second electrode body will be constructed of a material and be associated with an amperage that is different than that of the first electrode assembly 40 so as to separate a different and associated predetermined impurity from the water passing through the second vessel 50 when the second electrode body is energized.

The water purifying and recovery system 10 includes at least one centrifuge 60 that is configured to remove particles of an impurity from the water stream after the raw water has been passed through a vessel and energized by a respective electrode body as described above. The centrifuge 60 is in fluid communication with a respective outlet of a respective vessel such as, in one embodiment, the first vessel 20. In another embodiment, the centrifuge 60 may be operatively coupled to a last vessel in a series of vessels (FIG. 1). The centrifuge 60 is configured to operate according the principle of sedimentation in which centripetal acceleration causes denser particles to move outwardly in a radial manner while less dense substances are displaced and move toward the center or filter to a bottom area. Specifically, a water stream received into the centrifuge 60 after having passed through a respective vessel and energized is centripetally rotated which causes the separated impurity particles to move outwardly and the purified water to be separated.

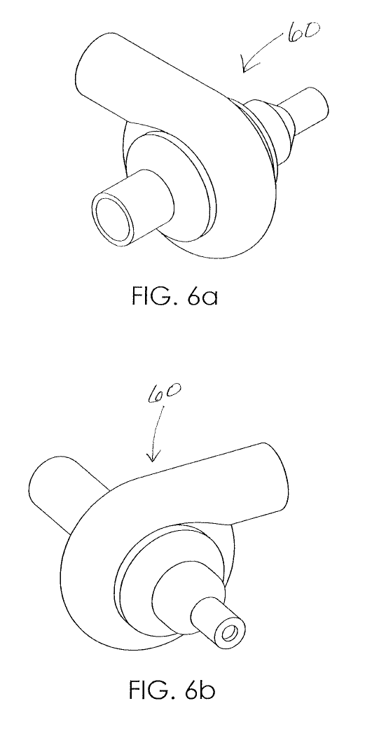

The separated impurity may be deposited or otherwise collected into a waste reclamation tank 14 while the purified water may be collected in a clean water collection tank 16 (FIG. 1). In some embodiments, more than one centrifuge 60 may be used, such as being positioned after one or more vessels and again after further particular separation in a downstream vessel (FIG. 6). In such a configuration, more than one waste reclamation tank 14 may be implemented to collect respective separated impurities having different densities.

A unique aspect of the present invention is that the exemplary process does not result in a waste product that must be disposed of. In other words, even the impurities filtered from a water stream are collected in a form that may be reclaimed and reused. At each stage of filtration, such as in a stage that filters iron out of water, the filtered iron is collected in a reclamation tank for use in an appropriate application. For example, many of the impurities that are systematically collected may be used in concrete, fertilizer, steel structures, and the like, respectively.

In another aspect, the construction of the first and second vessels themselves provide increased numbers of variations of metal and amperage available to cause filtration and removal of impurities from the water stream. More particularly, a vessel is preferably constructed of stainless steel. In the present embodiment, however, each stainless steel vessel may also include at least one and preferably a plurality of enhanced reaction members 25 spaced apart and mounted to an inner surface of the vessel, the enhanced reaction members being constructed of a material other than stainless steel. Further, the enhanced reaction members may be constructed of a material different from the material of the electrode body. In an embodiment, for instance, a plurality of enhanced reaction members 25 may be constructed of nickel and coupled to the stainless steel inner surface of a respective vessel and the electrode body may be constructed of copper. Again, this unique construction enables the removal of even more specific impurities.

In use, a user or manager of the water purifying and recovery system 10 determines what impurity is to be removed from a quantity of raw water that may be stored in a tank or natural reservoir. This determination will then enable the user to determine an appropriate electrode assembly to insert into a first vessel 20. It will also be determined if multiple vessels, each having an electrode assembly associated with a respective impurity to be removed. In other words, multiple stations or stages may be prepared in order to remove a plurality of impurities from a body of water. For instance, it may take 6 to 10 stages and configurations to properly transform oil field water into drinking water. Then, respective electrode assemblies are energized with electricity and respective impurities are molecularly separated from the water in respective vessels. The water is routed through one or more centrifuge 60 and collected in solid form apart from the purified water.

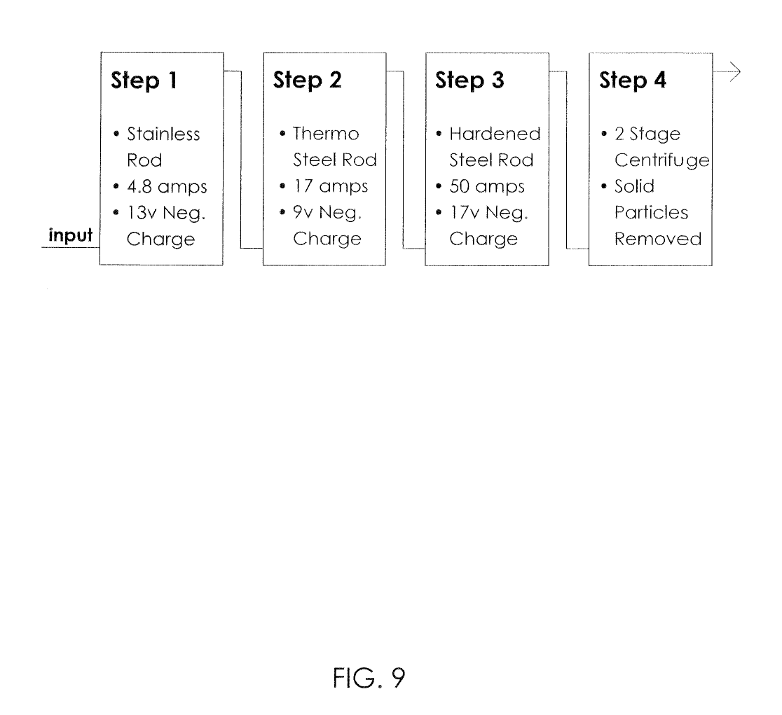

The many stages of a water purification process are shown in FIGS. 9 to 11 of the accompanying drawings. Each figure represents a multi-stage or multi-step process that includes many variations of rod construction, amperage, and voltage associated with specific impurities to be removed from a water stream according to the system and method of water purification described above.

It is understood that while certain forms of this invention have been illustrated and described, it is not limited thereto except insofar as such limitations are included in the following claims and allowable functional equivalents thereof.

1. A method for purifying and recovering water from a single water stream, comprising:
receiving water from the single water stream into a first vessel defining an interior area and having an inlet for receiving water into said interior area to be purified and an outlet for draining the water from said interior area, said first vessel defining an open top in communication with said interior area;
passing the received water over a first electrode assembly situated in the interior area of said first vessel, said first electrode assembly comprising:
a first cap selectively situated in said open top of said first vessel;
a first electrode body operatively depending from said first cap and positioned in said interior area of said first vessel, said first electrode assembly being electrically connected to an electricity source and configured to energize said first electrode body;
separating a predetermined first impurity from the water that is in said interior area of said first vessel by energizing said first electrode body;
wherein said first electrode body is constructed of a predetermined metal and is energized with a predetermined amperage and a predetermined polarity associated with said first impurity;
connecting said outlet of said first vessel to an inlet of a second vessel, said second vessel defining an interior area and having an inlet for receiving water from said first vessel into said interior area to be purified and an outlet for draining the purified water from said interior area, said second vessel defining an open top in communication with said interior area;
receiving the water from said first vessel into said second vessel;
passing said received water from said first vessel over a second electrode assembly situated in said second vessel, said second electrode assembly comprising:
a second cap selectively situated in said open top of said second vessel;
a second electrode body operatively depending from said second cap and positioned in said interior area of said second vessel, said second electrode body being electrically connected to an electricity source and configured to energize said second electrode body;
separating a predetermined second impurity from the water that is in said interior area of said second vessel by energizing said second electrode body;
wherein said second electrode body is constructed of a predetermined metal and is energized with a predetermined amperage and a predetermined polarity associated with said second impurity;
wherein said configuration of said second electrode body is different than said configuration of said first electrode body and said predetermined first impurity being different than said predetermined second impurity.

2. The method for purifying and recovering water as in claim 1, wherein said first vessel is constructed of stainless steel and includes a plurality of auxiliary reaction members spaced apart from one another in said interior area of said first vessel, each reaction member being constructed of a metal other than stainless steel and that is different from a material by which said first electrode body is constructed.

3. The method for purifying and recovering water as in claim 2, wherein said second vessel is constructed of stainless steel and includes a plurality of auxiliary reaction members spaced apart from one another in said interior area of said second vessel, each reaction member being constructed of a metal other than stainless steel and that is different from a material by which said second electrode body is constructed.

4. The method for purifying and recovering water as in claim 3, wherein:
said auxiliary reaction members of said first vessel are constructed of nickel;
said auxiliary reaction members of said second vessel are constructed of nickel.

5. The method for purifying and recovering water as in claim 3, wherein said auxiliary reaction members and said stainless steel construction of said first vessel have a singular integrated construction.

6. The method for purifying and recovering water as in claim 1, wherein said predetermined metal is taken from a group including copper, lead, nickel, and aluminum.

7. The method for purifying and recovering water as in claim 1, wherein said predetermined metal is taken from a group including steel, cast iron, and carbide.

8. The method for purifying and recovering water as in claim 1, wherein:
said first vessel has a generally cylindrical configuration and includes an inner surface adjacent said top having a threaded configuration; and
said cap of said first electrode assembly includes an outer surface having a threaded configuration such that said cap is removably coupled to said inner surface of said first vessel.

9. The method for purifying and recovering water as in claim 1, wherein said first electrode assembly is removable and replaceable with a second electrode assembly that is configured to separate a predetermined second impurity from the water that is in said interior area of said first vessel when energized, said configuration of said second electrode assembly being different than said configuration of said first electrode assembly and said predetermined second impurity being different than said predetermined first impurity.

10. The water purifying and recovery system as in claim 10, wherein said outlet of said first vessel is in fluid communication with said inlet of said second vessel.

11. The water purifying and recovery system as in claim 10, wherein said first vessel and said second vessel are operatively connected in a series arrangement.

12. The water purifying and recovery system as in claim 11, wherein said second vessel includes a plurality of second vessels in fluid communication with said first vessel in a series arrangement.

13. The water purifying and recovery system as in claim 1, further comprising the steps including:
separating filtered impurities into a reclamation tank and filtered water into a clean water tank via a centrifuge;
reclaiming and reusing said separated impurities that are separated into said reclamation tank.

14. The water purifying and recovery system as in claim 2, further comprising the steps including:
separating filtered impurities into a reclamation tank and filtered water into a clean water tank via a centrifuge;
reclaiming and reusing said separated impurities that are separated into said reclamation tank.
